(19) United States
(12) Patent Application Publication
(10) Pub. No.: US 2019/0118325 A1
(43) Pub. Date: Apr. 25, 2019

(54) METHODS OF MANUFACTURING PISTOL FRAMES

(71) Applicants: Swetal K. Patel, Dallas, GA (US); Michael Galinac, Powder Springs, GA (US)

(72) Inventors: Swetal K. Patel, Dallas, GA (US); Michael Galinac, Powder Springs, GA (US)

(21) Appl. No.: 15/789,674

(22) Filed: Oct. 20, 2017

(51) Int. Cl. B23Q 15/007; F41A 11/00; B23C 3/00; B23P 15/00; G05B 19/4099

(52) U.S. Cl. CPC B23Q 15/007; F41A 11/00; B23C 3/00; F41C 3/00; G05B 19/4099; B23C 2270/18; B23C 2215/00; B23P 15/00

(57) ABSTRACT

Various embodiments of manufacturing pistol frames are described. According to various embodiments, a left pistol frame portion is fabricated. A separate right pistol frame portion is also fabricated. The left pistol frame portion is attached to the right pistol frame portion to form a pistol frame.

### BACKGROUND

Some pistols have polymer frames. Polymer frames can be manufactured using an injection molding process and often include embedded steel inserts to provide the frame with rigidity. Polymer frames may also include steel inserts that interface with other steel components, such as the slide or the barrel. Other components, such as trigger components, a magazine release, and slide locks can also be integrated with a polymer frame.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1D are various views of a pistol frame according to various embodiments of the present disclosure.

FIGS. 2A-2D are various views of a left pistol frame portion of the pistol frame of FIGS. 1A-1D according to various embodiments of the present disclosure.

FIGS. 3A-3D are various views of a right pistol frame portion of the pistol frame of FIGS. 1A-1D according to various embodiments of the present disclosure.

### DETAILED DESCRIPTION

The present disclosure relates to various methods of manufacturing pistol frames. In accordance with various embodiments of the present disclosure, a left frame portion and a separate right frame portion of a pistol frame can be fabricated. One or more recesses can be created in the left pistol frame portion and/or the right pistol frame portion so that, when the left and right pistol frame portions are joined together, the left pistol frame portion and right pistol frame portion form one or more internal cavities. The cavities can be designed to accommodate various functional components, such as components for a trigger block, slide stop, trigger housing, magazine release and/or magazine well.

Fabricating the left frame portion separately from the right frame portion can facilitate the manufacturing of metallic pistol frames. That is, while polymer pistol frames having various cavities may be manufactured using injection molding techniques, it can be extremely difficult, or impossible, to form similar cavities when fabricating a pistol frame from a single piece of metal. Accordingly, embodiments of the present disclosure can facilitate manufacturing of pistol frames, including metallic pistol frames, that have internal cavities.

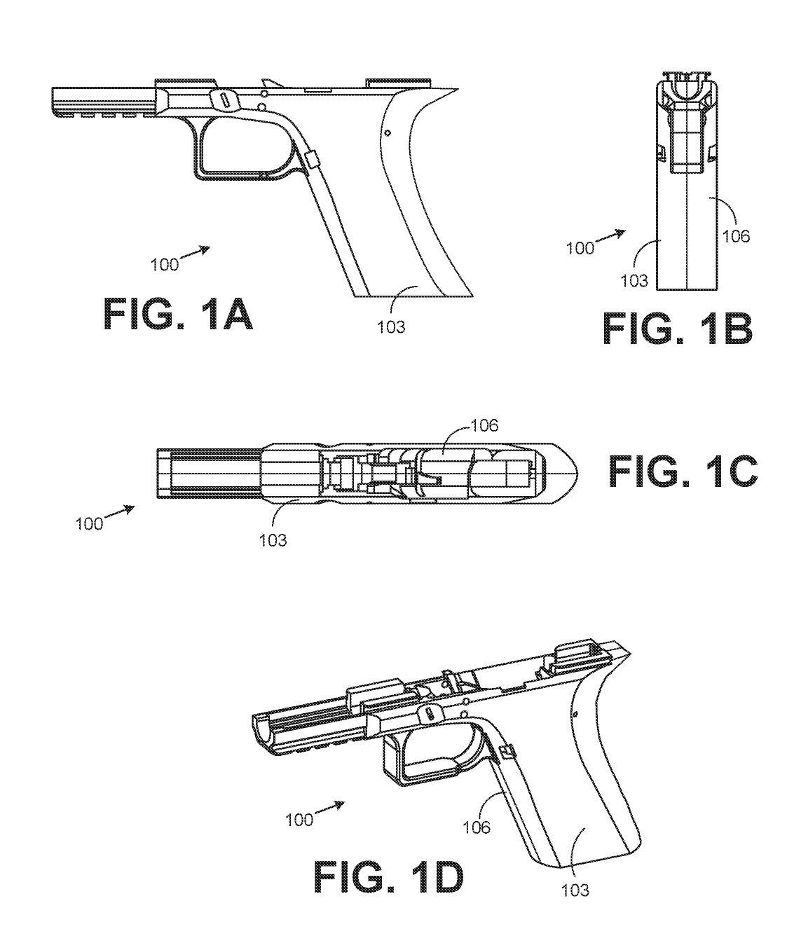

With reference to FIGS. 1A-1D, shown are multiple views of an example of a pistol frame 100 according to various embodiments. In particular, FIG. 1A is a side view of the pistol frame 100, FIG. 1B is a rear view of the pistol frame 100, FIG. 1C is a top view of the pistol frame 100, and FIG. 1D is a perspective view of the pistol frame 100. The pistol frame 100 can be integrated with a slide assembly, trigger assembly, magazine, barrel assembly, and/or other components, as can be appreciated.

The pistol frame 100 can be constructed of various types of materials. In some embodiments, the pistol frame 100 can be a metallic pistol frame constructed from ferrous and/or non-ferrous metals. For example, the pistol frame 100 can be constructed of stainless steel, aluminum, titanium, and/or other types of metals.

As best shown in FIGS. 1B-1C, the pistol frame 100 can include a left pistol frame portion 103 and a right pistol frame portion 106. The left pistol frame portion 103 and the right pistol frame portion 106 can be fabricated as separate components and then joined, as shown, to form the pistol frame 100.

The interior of the pistol frame 100 can include one or more cavities, which can be designed to accommodate various functional components. For example, the pistol frame 100 can include one or more cavities for a trigger block, a slide stop, a trigger housing, a magazine release, a magazine, and/or other components.

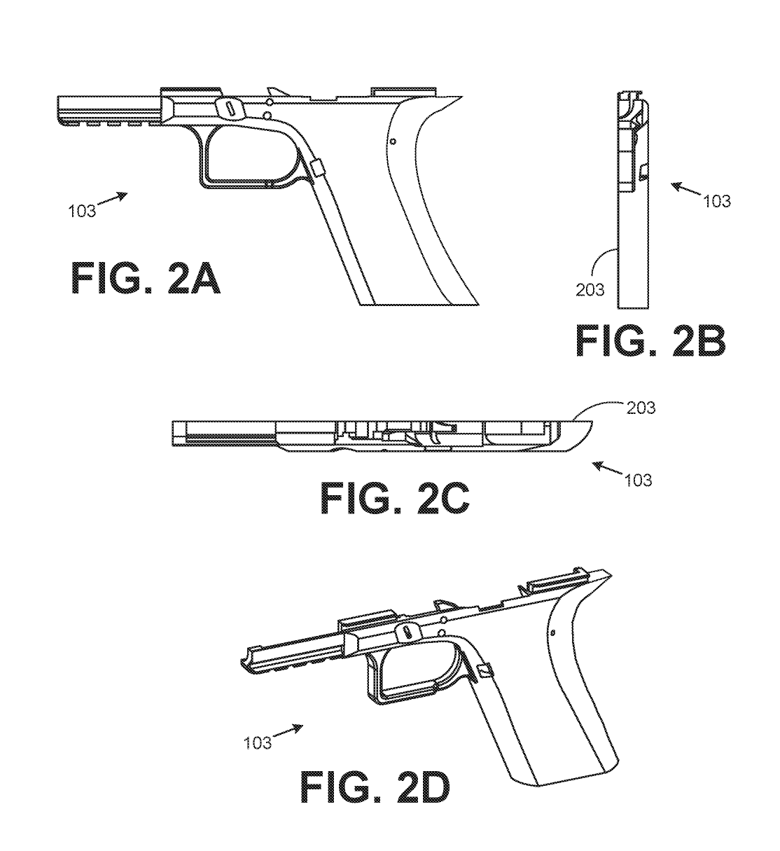

With reference to FIGS. 2A-2D, shown are multiple views of an example of the left pistol frame portion 103 of the pistol frame 100. In some embodiments, the left pistol frame portion 103 can be fabricated from a single metallic blank. For example, a computer numerical control (CNC) system can be programmed to mill the left pistol frame portion 103 from a metallic blank.

In the embodiment illustrated in FIGS. 2A-2D, the portion of the interior surface 203 of the left pistol frame portion 103 that contacts the right pistol frame portion 106 is flat. However, in alternative embodiments, the portion of the interior surface 203 that contacts the right pistol frame portion may include protrusions and/or grooves that can interface with corresponding protrusions and/or grooves in the right pistol frame portion 106.

As described above, the pistol frame 100 may include one or more cavities for various components. To form a cavity, a recess can be created in the interior surface 203 of the left pistol frame portion 103 using, for example, a CNC system. For some cavities, there can be a corresponding recess formed in the right pistol frame portion 106. Accordingly, when the left pistol frame portion 103 is joined to the right pistol frame portion 106, a recess in the left pistol frame portion 103 and a corresponding recess in the right pistol frame portion 106 can align and form a cavity. The walls of the respective recesses in the left pistol frame portion 103 and the right pistol frame portion 106 can thus be considered cavity walls.

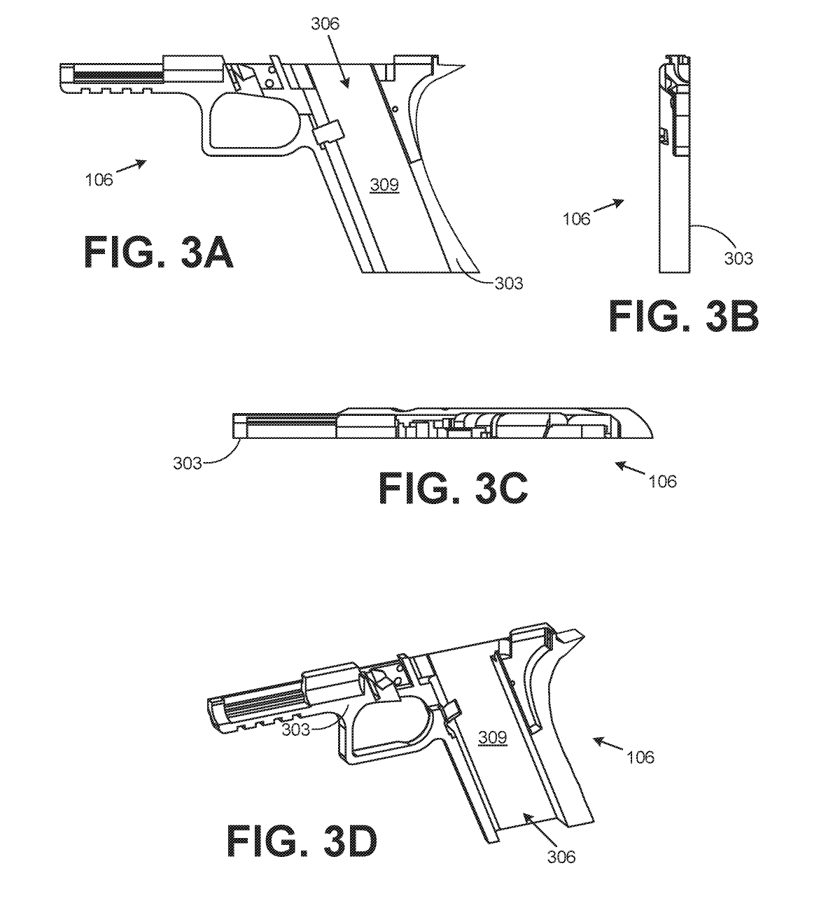

With reference to FIGS. 3A-3D, shown are multiple views of an example of the right pistol frame portion 106 of the pistol frame 100. Similar to the left pistol frame portion 103, the right pistol frame portion 106 can be fabricated from a single metallic blank. For example, a CNC system can be programmed to mill the right pistol frame portion 106 from a metallic blank. In some embodiments, the left pistol frame portion 103 can be fabricated from a first metallic blank, and the right pistol frame portion 106 can be fabricated from a second metallic blank. In other embodiments, the left pistol frame portion 103 and the right pistol frame portion 106 can be milled from the same metallic blank.

In the embodiment illustrated in FIGS. 3A-3D, the portion of the interior surface 303 of the right pistol frame portion 106 that contacts the left pistol frame portion 103 is flat. However, in alternative embodiments, the interior surface 303 may include protrusions and/or grooves that can interface with corresponding protrusions and/or grooves in the left pistol frame portion 103.

An example of a recess 306 in the right pistol frame portion 106 is visible in FIGS. 3A and 3D. As described above, the recess 306 can be formed by, for example, using a mill to remove a portion of the interior the right pistol frame portion 106. In this way, a cavity wall 309 can be defined in the recess. When the right pistol frame portion 106 is attached to the left pistol frame portion 103, the recess 306 can align with a corresponding recess in the left pistol frame portion 103, thereby forming an internal cavity in the pistol frame 100 defined by the cavity wall 309 of the recess 306 of the right pistol frame portion and the corresponding wall of the recess of the left pistol frame portion.

Once the left pistol frame portion 103 and the right pistol frame portion 106 have been fabricated, the left pistol frame portion 103 and the right pistol frame portion 106 can be assembled to form the pistol frame 100. For example, the left pistol frame portion 103 can be attached directly or indirectly to the left pistol frame portion 103 by welding the components together. In alternative embodiments, the left pistol frame portion 103 and the right pistol frame portion 106 can be attached using rivets, screws, or other techniques. It is noted that, in some embodiments, various internal components can be placed within appropriate recesses in the left pistol frame portion 103 and/or right pistol frame portion 106 prior to these components being attached to each other.

In some embodiments, the pistol frame 100 can be a metallic pistol frame 100 that is compatible with components designed for preexisting pistols that have polymer pistol frames. For example, the pistol frame 100 can be a metallic frame that is compatible with components, such as trigger components, magazine releases, slide locks, and barrel assemblies, that were designed for use with polymer pistol frames, such as those available from GLOCK, SMITH & WESSON, TAURUS, SIG SAUER, HECKLER & KOCK, RUGER, SPRINGFIELD ARMORY, BERETTA, WALTHER, FN HERSTAL, and others. Accordingly, a preexisting pistol having a polymer frame can be retrofitted to have a metallic pistol frame 100 using the manufacturing techniques as described herein. Moreover, a metallic pistol frame 100 can be manufactured and use readily-available parts, such as such as trigger components, magazine releases, slide locks, and barrel assemblies, that were designed for polymer pistol frames.

To create a metal pistol frame 100 that can use components designed for a preexisting pistol having a polymer frame, the preexisting pistol can be disassembled, and the dimensions of its internal cavities, recesses, and other features can be measured. A computer aided design (CAD) model of a metal left pistol frame portion 103 and a metal right pistol frame portion 106 can then be designed based around the measured dimensions of the polymer pistol.

While particular embodiments of the present disclosure have been described in detail in the foregoing description and figures for purposes of example, those skilled in the art will understand that variations and modifications may be made without departing from the scope of the disclosure. All such variations and modifications are intended to be included within the scope of the present disclosure, as protected by the following claims.

Therefore, the following is claimed:

1. A method of manufacturing a pistol frame, comprising:
fabricating a left pistol frame portion, the left pistol frame portion comprising a left cavity wall, the left pistol frame portion being metallic;
fabricating a right pistol frame portion separately from the left pistol frame portion, the right pistol frame portion comprising a right cavity wall, the right pistol frame portion being metallic; and
attaching the left pistol frame portion to the right pistol frame portion to form a metallic pistol frame, the metallic pistol frame comprising a cavity defined by at least the left cavity wall and the right cavity wall.

2. The method of claim 1, further comprising:
generating first computer aided design (CAD) model data for the left pistol frame portion based at least in part on a plurality of first measurements of a polymer pistol frame; and
generating second CAD model data for the right pistol frame portion based at least in part on a plurality of second measurements of the polymer pistol frame.

3. The method of claim 1, wherein attaching the left pistol frame portion to the right pistol frame portion comprises welding the left pistol frame portion to the right pistol frame portion.

4. The method of claim 1, wherein attaching the left pistol frame portion to the right pistol frame portion comprises riveting the left pistol frame portion to the right pistol frame portion.

5. The method of claim 1, wherein attaching the left pistol frame portion to the right pistol frame portion comprises attaching the left pistol frame portion to the right pistol frame portion using at least one screw.

6. The method of claim 1, wherein fabricating the left pistol frame portion comprises machining the left pistol frame portion using a computer numerical control (CNC) system, and wherein fabricating the right pistol frame portion comprises machining the right pistol frame portion using the CNC system.

7. A method, comprising:
fabricating a left pistol frame portion;
fabricating a right pistol frame portion separately from the left pistol frame portion; and
attaching the left pistol frame portion to the right pistol frame portion to form a pistol frame, the pistol frame comprising at least one cavity.

8. The method of claim 7, further comprising:
generating first computer aided design (CAD) model data for the left pistol frame portion based at least in part on a plurality of first measurements of a polymer pistol frame; and
generating second CAD model data for the right pistol frame portion based at least in part on a plurality of second measurements of the polymer pistol frame.

9. The method of claim 7, wherein fabricating the left pistol frame portion comprises machining the left pistol frame portion using a computer numerical control (CNC) system, and wherein fabricating the right pistol frame portion comprises machining the right pistol frame portion using the CNC system.

10. The method of claim 9, wherein the right pistol frame portion and the left pistol frame portion are machined simultaneously by the CNC system.

11. The method of claim 7, wherein attaching the left pistol frame portion to the right pistol frame portion comprises at least one of welding, screwing, or riveting the left pistol frame portion to the right pistol frame portion.
